(19) United States
(12) Patent Application Publication
(10) Pub. No.: US 2022/0071190 A1
(43) Pub. Date: Mar. 10, 2022

(54) ELECTROMAGNETIC CHARGE-SENSITIVE ELECTRIC MOSQUITO SWATTER

(71) Applicant: Foshan Shunde Lexueer Electric Co., Ltd., Foshan, Guangdong (CN)

(72) Inventor: Baozhu LIAO, Foshan, Guangdong (CN)

(21) Appl. No.: 17/417,782

(22) PCT Filed: Dec. 26, 2019
(86) PCT No.: PCT/CN2019/128811

§ 371 Date: Jun. 24, 2021

(30) Foreign Application Priority Data
Dec. 27, 2018 (CN) 201811613502.6

(51) Int. Cl. A01M 3/02; G05F 1/10

(52) U.S. Cl. CPC A01M 3/025; G05F 1/10

(57) ABSTRACT

An electromagnetic charge-sensitive electric mosquito swatter, comprising a charging-discharging circuit (1), a boost circuit (3) and a central control circuit (4). The charging-discharging circuit (1) provides required power to the boost circuit (3). Also comprised are an electromagnetic charge space scanning circuit (5) and a gate circuit (6); the gate circuit (6) is bridged between the electromagnetic charge space scanning circuit (5) and the central control circuit (4) so that when the electromagnetic charge space scanning circuit (5) senses a holding signal of a human hand holding the swatter, the holding signal is converted into a startup signal by means of the gate circuit (6) and is transmitted to the central control circuit (4); and the central control circuit (4) drives the charging-discharging circuit (1) to provide power to the boost circuit (3). The present mosquito swatter has the advantages of being convenient and safe to use and being effective in shocking mosquitos.

### BACKGROUND OF THE INVENTION

The present invention relates to the technical field of electric mosquito swatters, in particular relates to an electromagnetic charge-induced electric mosquito swatter.

The start buttons of existing electric mosquito swatters include the ordinary pushbutton type and the single-button capacitive touch type. The ordinary pushbutton type is prone to poor contact, fatigue and other problems; the single-button capacitive touch type is prone to triggering and outputting high voltages optionally, meaning great safety risks for users with children. If the start buttons of such electric mosquito swatters are touched by mice or other animals, there will be uncertain hazards. In addition, the start button of a traditional electric mosquito swatter, no matter it belongs to the pushbutton type or the single-button capacitive touch type, is installed at certain position of the handle of such electric mosquito swatter; when a mosquito approaches a human body, the user needs to spend time searching for the start-button position, but the opportunity to swat the mosquito is fleeting, so such traditional electric mosquito swatter greatly affects the user's mosquito killing efficiency.

### BRIEF SUMMARY OF THE INVENTION

A purpose of the present invention aims to provide an electromagnetic charge-induced electric mosquito swatter characterized by convenient and safe sue as well as good mosquito killing effect.

The purpose of the present invention is realized as follows:

An electromagnetic charge-induced electric mosquito swatter compromises a charging and discharging circuit, a voltage-boosting circuit and a central control circuit, among which the charging and discharging circuit provides the power for the voltage boosting circuit; the present invention also comprises an electromagnetic charge space scanning circuit and a gate circuit which is bridged between the electromagnetic charge space scanning circuit and the central control circuit so that when inducing the hand holding signal of the electric mosquito swatter, the electromagnetic charge space scanning circuit can convert such hand holding signal into an activating signal via the gate circuit and then transmit the activating signal to the central control circuit which then actuates the charging and discharging circuit and provides the power for the voltage boosting circuit; such electric mosquito swatter has the advantages of convenient and safe use as well as good mosquito killing effect; when such electric mosquito swatter is held by one hand, the electromagnetic charge space scanning circuit will induce the signal of change in external space electromagnetic field and space charges and utilize such change signal for operation and processing, induce the difference of human hands from other objects and thus judge whether to output the signal; when it is one hand, it will output the corresponding electric signal to the electromagnetic charge space scanning circuit for operation and processing and then the electromagnetic charge space scanning circuit will output the activating signal to connect the power supply of the voltage-boosting circuit which then output the high direct voltage to the net of the electric mosquito swatter and thus achieve the mosquito killing aim; therefore, such electric mosquito swatter can avoid the disadvantages of an ordinary capacitor such as mutual interference and malfunction in the touch-control mode and low sensitivity, it is safe and convenient while obviously increasing the mosquito killing effect.

The present invention also provides the following technical solutions:

As a further solution of the present invention that: the electromagnetic charge space scanning circuit comprises a chip IC2, a first electrode, a resistor R9 and a capacitor C6 among which the first electrode is earthed via the capacitor C6, the resistor R9 is connected between the chip IC2 and the first electrode, the gate circuit is connected at the outlet end of the first high voltage of the chip IC2, the gate circuit will output the activating signal of the low voltage to the central control circuit after receiving the high-voltage hand-holding signal transmitted from the chip IC2.

As a further solution of the present invention that: the electromagnetic charge space scanning circuit also comprises a second electrode, a resistor R10 and a capacitor C7 among which the second electrode is earthed via the capacitor C7, the resistor R10 is connected between the chip IC2 and the second electrode, the gate circuit is connected at the outlet end of the second high voltage of the chip IC2, the gate circuit will output the activating signal of the low voltage to the central control circuit after receiving the high-voltage hand-holding signal transmitted from the chip IC2.

As a further solution of the present invention that: it also comprises a handle, among which the first electrode and the second electrode are designed on the front side and the rear side of the handle respectively, the first electrode and the second electrode are used to send the electromagnetic waves and detect space charge; only when the positions of the handle corresponding to the first electrode and the second electrode are held by one hand at the same time, the chip IC2 will judge that such hand holding way is valid and then the output end of its first high voltage and the output end of its second high voltage will output the high-voltage hand-holding signal to the gate circuit.

The chip IC2 in the electromagnetic charge space scanning circuit alternately sends pulses of specific frequency to generate an electromagnetic field and thus make a space electric field; the first electrode and the second electrode combine to execute the charge space scanning mode, which effectively avoids the problems such as mutual interference, malfunction and low sensitivity; the present invention also can detect and distinguish a human hand from any other object, for example, if it is a human hand tightly holding the handle of the electric mosquito swatter at an angle of 180 degrees, the chip IC2 will judge that such hand holding way is valid and the mosquito killing operation can be done; otherwise, the mosquito killing operation will be ineffective.

As a further solution of the present invention that: the gate circuit comprises a triode Q5, a resistor R17, a triode Q6 and a resistor R18 among which the emitting electrode of the triode Q5 is connected with the collector of the triode Q6, the emitting electrode of the triode Q6 is earthed, the collector of the triode Q5 is connected with the central control circuit, one end of the resistor R17 and one end of the resistor R18 are connected with the base of the triode Q5 and the base of the triode Q6 respectively, the other end of the resistor R17 and the other end of the resistor R18 are connected with the output end of the first high voltage and the output end of the second high voltage of the chip IC2 respectively, the triode Q5 and the triode Q6 serve as the signal communication and gate circuits between the central control circuit and the chip IC2; when the chip IC2 receives the signal that the front side and the rear side of the handle are held by one hand at the same time, the chip IC2 will output high voltages respectively to actuate the triode Q5 and the triode 06 so that the collector of the triode Q5 is connected to one end foot of the central control circuit and generate the low-voltage signal and then the central control circuit will actuate the charging and discharging circuit as per such signal and thus supply the power for the voltage-boosting circuit.

As a further solution of the present invention that: the central control circuit comprises a chip IC1, among which the low-voltage signal input end of the chip IC1 is connected with the collector of the triode Q5, one end foot of the chip 1 is connected with the charging and discharging circuit, the collector of the triode Q5 is connected to the low-voltage signal input end of the chip IC1 of the central control circuit, the chip IC1 will actuate the charging and discharging circuit as per such signal and thus supply the power for the voltage-boosting circuit.

As a further solution of the present invention that: the first electrode and the second electrode are 8˜10 mm wide and 30˜100 mm long; by installing two electrodes with the above width and length, the two electrodes form 180 degrees in space, each electrode is connected to the chip IC2 via the resistors R9 and R10 respectively; after that, the chip IC2 will actively and alternately output pulses of specific frequency within a certain period of time to generate a corresponding magnetic field in space and then execute uninterrupted electromagnetic charge space scanning together with the corresponding electric field generated from certain voltage imposed between the two electrodes so as to detect the difference between a human hand and any other object; in a word, the present invention embodies the biggest feature of a human-based product.

As a further solution of the present invention that: it also comprises a Nixie tube which is connected with the charging and discharging circuit so that the currently charged and discharged quantities of electricity can be displayed via the Nixie tube.

It also comprises the voltage-stabilizing circuit which is bridged between the charging and discharging circuit and the electromagnetic charge space scanning circuit so that it can supply stable power for the chip IC2.

As a further solution of the present invention that: the voltage-stabilizing circuit comprises a voltage-stabilizing chip IC3, a capacitor C1 and a capacitor C2 among which the voltage-stabilizing chip IC3 is a three-end voltage-stabilizing chip with the model HT7133, one end of the capacitor C1 and one end of the capacitor C2 are connected with the input and output ends of the voltage-stabilizing chip IC3 respectively, the other end of the capacitor C1 and the other end of the capacitor C2 are connected together with the earthing end of the voltage-stabilizing chip IC3, the input end of the voltage-stabilizing chip IC3 is also connected with the charging and discharging circuit, and its output end is connected with the power input end of the chip IC2 and thus the voltage-stabilizing circuit can supply stable power for the chip IC2.

The present invention has the beneficial effects that:

(1) When such electric mosquito swatter is held by one hand, the electromagnetic charge space scanning circuit will induce the signal of change in external space electromagnetic field and space charges and utilize such change signal for operation and processing, induce the difference of human hands from other objects and thus judge whether to output the signal; when it is one hand, it will output the corresponding electric signal to the electromagnetic charge space scanning circuit for operation and processing and then the electromagnetic charge space scanning circuit will output the activating signal to connect the power supply of the voltage-boosting circuit which then output the high direct voltage to the net of the electric mosquito swatter and thus achieve the mosquito killing aim; therefore, such electric mosquito swatter can avoid the disadvantages of an ordinary capacitor such as mutual interference and malfunction in the touch-control mode and low sensitivity, it is safe and convenient while obviously increasing the mosquito killing effect.

(2) Furthermore, the first electrode and the second electrode are designed on the front side and the rear side of the handle respectively at the same horizontal height; when a human hand tightly holds the handle of the electric mosquito swatter at an angle of 180 degrees, the chip IC2 will judge that such hand holding way is valid and the mosquito killing operation can be done; otherwise, the mosquito killing operation will be ineffective; the higher the accuracy of detecting the hand holding way is, the better the mosquito killing effect.

(3) In addition, the first electrode and the second electrode are 8˜10 mm wide and 30˜100 mm long; by installing two electrodes with the above width and length, the two electrodes form 180 degrees in space, the electrodes are connected to the chip IC2 via the resistors R9 and R10 respectively; after that, the chip IC2 will actively and alternately output pulses of specific frequency within a certain period of time to generate a corresponding magnetic field in space and then execute uninterrupted electromagnetic charge space scanning together with the corresponding electric field generated from certain voltage imposed between the two electrodes so as to detect the difference between a human hand and any other object; in a word, the present invention embodies the biggest feature of a human-based product.

### BRIEF DESCRIPTION OF THE DRAWINGS

FIG. 1 is the schematic circuit diagram of the electromagnetic charge-induced electric mosquito swatter in the present invention.

FIG. 2 is the schematic diagram of the first and second electrodes installed onto the handle of the electric mosquito swatter in the present invention.

### DETAILED DESCRIPTION OF THE INVENTION

The present invention will be described more clearly and fully in conjunction with the accompanying drawings and embodiments:

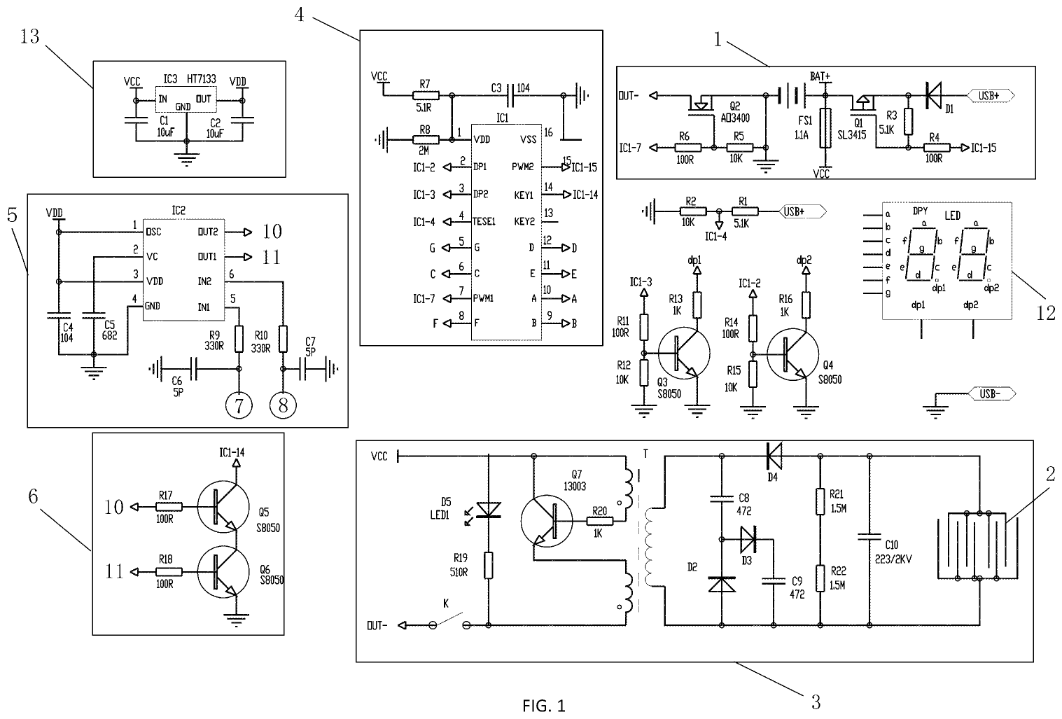

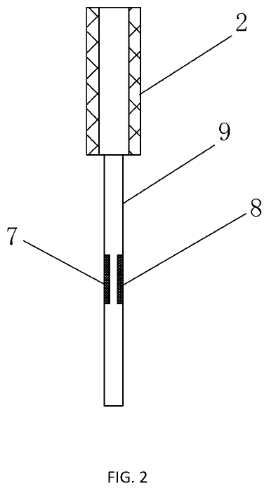

As shown in FIG. 1 and FIG. 2, an electromagnetic charge-induced electric mosquito swatter compromises a charging and discharging circuit (1), a voltage boosting circuit (3) and a central control circuit (4) among which the charging and discharging circuit (1) provides the power for the voltage boosting circuit (3); wherein the present invention also comprises an electromagnetic charge space scanning circuit (5) and a gate circuit (6) which is bridged between the electromagnetic charge space scanning circuit (5) and the central control circuit (4) so that when inducing the hand holding signal that the electric mosquito swatter is held by one hand, the electromagnetic charge space scanning circuit (5) can convert such hand holding signal into an activating signal via the gate circuit (6) and then transmit the activating signal to the central control circuit (4) which then actuates the charging and discharging circuit (1) and provides the power for the voltage boosting circuit (3).

As a concrete solution of the present invention that: the electromagnetic charge space scanning circuit (5) comprises a chip IC2, a first electrode (7), a resistor R9 and a capacitor C6 among which the first electrode (7) is earthed via the capacitor C6, the resistor R9 is connected between the chip IC2 and the first electrode (7), the gate circuit (6) is connected at the outlet end (10) of the first high voltage of the chip IC2, the gate circuit (6) will output the activating signal of the low voltage to the central control circuit (4) after receiving the high-voltage hand-holding signal transmitted from the chip IC2.

As shown in the pictures, the electromagnetic charge space scanning circuit (5) also comprises a second electrode (8), a resistor R10 and a capacitor C7 among which the second electrode (8) is earthed via the capacitor C7, the resistor R10 is connected between the chip IC2 and the second electrode (8), the gate circuit (6) is connected at the outlet end (11) of the second high voltage of the chip IC2, the gate circuit (6) will output the activating signal of the low voltage to the central control circuit (4) after receiving the high-voltage hand-holding signal transmitted from the chip IC2.

As shown in FIG. 2, it also comprises a handle (9), among which the first electrode (7) and the second electrode (8) are designed on the front side (91) and the rear side (92) of the handle (9) respectively, the first electrode (7) and the second electrode (8) are used to send the electromagnetic waves and detect space charges; only when the positions of the handle corresponding to the first electrode (7) and the second electrode (8) are held by one hand at the same time, the chip IC2 will judge that such hand holding way is valid and then the output end (10) of its first high voltage and the output end (11) of its second high voltage will output the high-voltage hand-holding signals to the gate circuit (6).

As a concrete solution of the present invention that: the gate circuit (6) comprises a triode Q5, a resistor R17, a triode Q6 and a resistor R18 among which the emitting electrode of the triode Q5 is connected with the collector of the triode Q6, the emitting electrode of the triode Q6 is earthed, the collector of the triode Q5 is connected with the central control circuit, one end of the resistor R17 and one end of the resistor R18 are connected with the base of the triode Q5 and the base of the triode Q6 respectively, the other end of the resistor R17 and the other end of the resistor R18 are connected with the output end (10) of the first high voltage and the output end (11) of the second high voltage of the chip IC2 respectively, the triode Q5 and the triode Q6 serve as the signal communication and gate circuits between the central control circuit (4) and the chip IC2; when the chip IC2 receives the signal that the front side (91) and the rear side (92) of the handle (9) are held by one hand at the same time, the chip IC2 will output high voltages respectively to actuate the triode Q5 and the triode Q6 so that the collector of the triode Q5 is connected to one end foot of the central control circuit (4) and generate the low-voltage signal and then the central control circuit (4) will actuate the charging and discharging circuit (1) as per such signal and thus supply the power for the voltage-boosting circuit (3).

As a further solution of the present invention that: the central control circuit comprises a chip IC1, among which the low-voltage signal input end of the chip IC1 is connected with the collector of the triode Q5, one end foot of the chip 1 is connected with the charging and discharging circuit, the collector of the triode Q5 is connected to the low-voltage signal input end of the chip 1 of the central control circuit, the chip IC1 will actuate the charging and discharging circuit as per such signal and thus supply the power for the voltage-boosting circuit.

The first electrode and the second electrode are 8˜10 mm wide and 30˜100 mm long.

As a concrete solution of the present invention that: it also comprises a Nixie tube (12) and a voltage-stabilizing circuit (13) among which the Nixie tube (12) is connected with the charging and discharging circuit (1) so that the currently charged and discharged quantities of electricity are displayed via the Nixie tube (12), and the voltage-stabilizing circuit (13) is bridged between the charging and discharging circuit (1) and the electromagnetic charge space scanning circuit (5) so that it can supply stable power for the chip IC2.

Among, the voltage-stabilizing circuit comprises a voltage-stabilizing chip IC3, a capacitor C1 and a capacitor C2 among which the voltage-stabilizing chip IC3 is a three-terminal voltage-stabilizing chip with the model HT7133, one end of the capacitor C1 and one end of the capacitor C2 are connected with the input and output ends of the voltage-stabilizing chip IC3 respectively, the other end of the capacitor C1 and the other end of the capacitor C2 are connected together with the earthing end of the voltage-stabilizing chip IC3, the input end of the voltage-stabilizing chip IC3 is also connected with the charging and discharging circuit, and its output end is connected with the power input end of the chip IC2 and thus the voltage-stabilizing circuit can supply stable power for the chip IC2.

For the charging and discharging circuit (1), the voltage-stabilizing circuit (13) and the voltage-boosting circuit (3) of the present invention, the charging and discharging circuit (1) provides power for the voltage-boosting circuit (3), wherein the present invention also comprises the electromagnetic charge space scanning circuit (5).

The present invention mainly comprises the following four main circuits: the central control circuit (4), the voltage-stabilizing circuit (13), the electromagnetic charge space scanning circuit (5) and the voltage-boosting circuit (3).

I. Central control circuit (4): It is used for functions such as the charging and discharging of the triode Q1 and the triode Q2, the signal execution of the triode Q5, the triode Q6 and the gate circuit (6), the power-on and off of the voltage-boosting circuit (3).

The charging and discharging principle of the triode Q1 and the triode Q2: when the battery voltage of the electric mosquito swatter is lower than 4.0V, the chip IC1 will switch on the triode Q1 and then the USB charger will charge the battery via the diode D1 and the triode Q1 and display the percentage of the currently charged quantity of electricity via the Nixie tube (12); the battery voltage gets to 4.2V, the chip IC1 will switch off the triode Q1 and stop charging the battery and thus realize the overcharge protection; when the triode Q1 is switched on (namely in the charging status), the triode Q2 is controlled by the 7th foot of the chip IC1, the power supply of the voltage-boosting circuit (3) is disconnected and thus ensure that the mosquito killing operation cannot be done in the charging status.

When the battery is discharged, the chip IC1 will switch on the triode Q2 and power on the voltage-boosting circuit (3) and display the percentage of the currently discharged quantity of electricity via the Nixie tube (12); when the battery is discharged to 2.8V, the chip IC1 will switch off the triode Q2 and disconnect the power supply of the voltage-boosting circuit (3) and thus realize the over-discharge protection.

II. Triode Q5, triode Q6 and gate circuit (6): The triode Q5 and the triode 06 serve as the signal communication and gate circuits between the chip IC1 and the chip IC2; when the chip IC2 receives the signal that a human hand holds the handle (9) of the electric mosquito swatter at an angle of 180 degrees, the chip IC2 will output high voltages respectively to actuate the triode Q5 and the triode Q6 so that the triode Q5 is connected to the 14th foot of the chip IC1 and generate the low-voltage signal, the chip 1 will switch on the triode Q2 as per such signal and thus supply the power for the voltage-boosting circuit (3).

III. Voltage-stabilizing circuit (13): It is realized via the three-terminal voltage-stabilizing chip IC3 (HT7133); the voltage-stabilized power supply VDD is mainly used for MCU2; the space electric field and the space charges generated from MCU2 working with pure and stable DC power supply are stabler and more reliable and thus increase the anti-interference capacity.

IV. Electromagnetic charge space scanning circuit (5): It is mainly realized via the chip IC2; by installing the first electrode (7) and the second electrode (8) with specific width and length, the two electrodes form 180 degrees in space, the two electrodes are connected to the 5th foot and the 6th foot of the chip IC1 via the resistors R9 and R10 respectively; after that, the chip IC2 will actively and alternately output pulses of specific frequency within a certain period of time to generate a corresponding magnetic field in space and then execute uninterrupted electromagnetic charge space scanning together with the corresponding electric field generated from certain voltage imposed between the two electrodes so as to use a special programmed algorithm for detecting the difference between a human hand and any other object; in a word, the present invention embodies the biggest feature of a human-based product.

V. Voltage-boosting circuit (3): When the switch K1 and the triode Q2 are powered on, the voltage-boosting circuit (3) will be powered by the battery; in the high-frequency oscillating circuit consisted of the triode Q7, T and R20, the battery voltage is boosted to 1,000V via the high-frequency transformer and then tripled to 3,000V via the diodes D2, D3, D4, C8, C9 and C10; the DC high voltage of 3,000V is loaded to the net (2) of the electric mosquito swatter and thus achieve high-voltage mosquito killing aim.

1. The electromagnetic charge-induced electric mosquito swatter compromises a charging and discharging circuit (1), a voltage boosting circuit (3) and a central control circuit (4) among which the charging and discharging circuit (1) provides the power for the voltage boosting circuit (3); wherein the present invention also comprises an electromagnetic charge space scanning circuit (5) and a gate circuit (6) which is bridged between the electromagnetic charge space scanning circuit (5) and the central control circuit (4) so that when inducing the hand holding signal of the electric mosquito swatter, the electromagnetic charge space scanning circuit (5) can convert such hand holding signal into an activating signal via the gate circuit and then transmit the activating signal to the central control circuit (4) which then actuates the charging and discharging circuit (1) and provides the power for the voltage boosting circuit (3).

2. The electromagnetic charge-induced electric mosquito swatter in accordance with claim 1, wherein the electromagnetic charge space scanning circuit (5) comprises a chip IC2, a first electrode (7), a resistor R9 and a capacitor C6 among which the first electrode (7) is earthed via the capacitor C6, the resistor R9 is connected between the chip IC2 and the first electrode (7), the gate circuit (6) is connected at the outlet end (10) of the first high voltage of the chip IC2, the gate circuit (6) will output the activating signal of the low voltage to the central control circuit (4) after receiving the high-voltage hand-holding signal transmitted from the chip IC2.

3. The electromagnetic charge-induced electric mosquito swatter in accordance with claim 2, wherein the electromagnetic charge space scanning circuit (5) also comprises a second electrode (8), a resistor R10 and a capacitor C7 among which the second electrode (8) is earthed via the capacitor C7, the resistor R10 is connected between the chip IC2 and the second electrode (8), the gate circuit (6) is connected at the outlet end (11) of the second high voltage of the chip IC2, the gate circuit (6) will output the activating signal of the low voltage to the central control circuit (4) after receiving the high-voltage hand-holding signal transmitted from the chip IC2.

4. The electromagnetic charge-induced electric mosquito swatter in accordance with claim 3, wherein it also comprises a handle (9), among which the first electrode (7) and the second electrode (8) are designed on the front side (91) and the rear side (92) of the handle (9) respectively, the first electrode (7) and the second electrode (8) are used to send the electromagnetic waves and detect space charge; only when the positions of the handle (9) corresponding to the first electrode (7) and the second electrode (8) are held by one hand at the same time, the chip IC2 will judge that such hand holding way is valid and then the output end (10) of its first high voltage and the output end (11) of its second high voltage will output the high-voltage hand-holding signal to the gate circuit (6).

5. The electromagnetic charge-induced electric mosquito swatter in accordance with claim 4, wherein the gate circuit (6) comprises a triode Q5, a resistor R17, a triode Q6 and a resistor R18 among which the emitting electrode of the triode Q5 is connected with the collector of the triode Q6, the emitting electrode of the triode Q6 is earthed, the collector of the triode Q5 is connected with the central control circuit, one end of the resistor R17 and one end of the resistor R18 are connected with the base of the triode Q5 and the base of the triode Q6 respectively, the other end of the resistor R17 and the other end of the resistor R18 are connected with the output end (10) of the first high voltage and the output end (11) of the second high voltage of the chip IC2 respectively, the triode Q5 and the triode Q6 serve as the signal communication and gate circuits between the central control circuit (4) and the chip IC2; when the chip IC2 receives the signal that the front side (91) and the rear side (92) of the handle (9) are held by one hand at the same time, the chip IC2 will output high voltages respectively to actuate the triode Q5 and the triode Q6 so that the collector of the triode Q5 is connected to one end foot of the central control circuit (4) and generate the low-voltage signal and then the central control circuit (4) will actuate the charging and discharging circuit (1) as per such signal and thus supply the power for the voltage-boosting circuit (3).

6. The electromagnetic charge-induced electric mosquito swatter in accordance with claim 5, wherein the central control circuit (4) comprises a chip IC1, among which the low-voltage signal input end of the chip IC1 is connected with the collector of the triode Q5, one end foot of the chip IC1 is connected with the charging and discharging circuit (1), the collector of the triode Q5 is connected to the low-voltage signal input end of the chip IC1 of the central control circuit (4), the chip IC1 will actuate the charging and discharging circuit (1) as per such signal and thus supply the power for the voltage-boosting circuit (3).

7. The electromagnetic charge-induced electric mosquito swatter in accordance with claim 3, wherein the first electrode (7) and the second electrode (8) are 8˜10 mm wide and 30˜100 mm long.

8. The electromagnetic charge-induced electric mosquito swatter in accordance with claim 7, wherein it also comprises a Nixie tube (12) which is connected with the charging and discharging circuit (1) so that the currently charged and discharged quantities of electricity can be displayed via the Nixie tube (12).

9. The electromagnetic charge-induced electric mosquito swatter in accordance with claim 1, wherein it also comprises the voltage-stabilizing circuit (13) which is bridged between the charging and discharging circuit (1) and the electromagnetic charge space scanning circuit (5) so that it can supply stable power for the chip IC2.

10. The electromagnetic charge-induced electric mosquito swatter in accordance with claim 1, wherein the voltage-stabilizing circuit (13) comprises a voltage-stabilizing chip IC3, a capacitor C1 and a capacitor C2 among which the voltage-stabilizing chip IC3 is a three-terminal voltage-stabilizing chip with the model HT7133, one end of the capacitor C1 and one end of the capacitor C2 are connected with the input and output ends of the voltage-stabilizing chip IC3 respectively, the other end of the capacitor C1 and the other end of the capacitor C2 are connected together with the earthing end of the voltage-stabilizing chip IC3, the input end of the voltage-stabilizing chip IC3 is also connected with the charging and discharging circuit (1), and its output end is connected with the power input end of the chip IC2 and thus the voltage-stabilizing circuit (13) can supply stable power for the chip IC2.
